(19) United States
(12) Patent Application Publication
(10) Pub. No.: US 2005/0030418 A1
(43) Pub. Date: Feb. 10, 2005

(54) MOTORCYCLE CAMERA MOUNT

(75) Inventor: Harry Hoffman, San Carlos, CA (US)

Correspondence Address: PERKINS COIE LLP, P.O. BOX 2168, MENLO PARK, CA, 94026, US

(73) Assignee: Hoffman Metal Products, Inc., San Carlos, CA (US)

(21) Appl. No.: 10/876,807

(22) Filed: Jun. 25, 2004

(51) Int. Cl. H04N 7/18

(52) U.S. Cl. 348/373; 348/148

(57) ABSTRACT

Abstract of the Disclosure

A simple yet sturdy means of attaching a video camera to a motorcycle consisting of relatively few parts. The modular design of the mount includes a mounting bracket, an extension arm, an adjustment means and platform for attaching and supporting a camera. The entire assembly can be quickly and easily bolted on to a motorcycle fuel cap without special tools. Its design and application helps minimize potentially damaging and disruptive vibrations to the camera while the vehicle is in use, thus allowing for more stable recording.

### Detailed Description of the Invention

### FIELD OF THE INVENTION

This invention relates generally to camera support devices, and more specifically to a simple, yet extremely stable way of mounting a video camera to a motorcycle for effective filming while riding.

### BACKGROUND OF THE INVENTION

With the advent of affordable and lightweight digital video cameras it has become easier than ever for amateur filmmakers to record experiences and share them with others. Like most sportsmen, motorcycle and sport bike enthusiasts would like to have a record of doing the thing they enjoy. Naturally, capturing the sights and sounds of a ride from the rider's perspective would be the most thrilling thing, visually.

Because it would be nearly impossible for someone operating a high performance motorbike to try and hold a camera while at the same time safely operate their vehicle, it would be desirable to be able to attach a camera to a bike in such a way that would provide for optimal filming capability but would not interfere with the performance, balance or control of the bike.

Prior camera mounting devices such as U.S. patent 5,039,050 to Eidschun and Holtzman (1989) which was designed to attach to a "vehicle," are quite large and cumbersome. Despite the description of this mount as contained in the published patent, it is quite complex and has many parts. Tripod-type camera mounts such as this one can seriously limit or inhibit a motorcycle's performance due to its positioning and size. Further, its design was not contemplated for use with high performance motorcycles specifically but rather, any "vehicle."

Another problem with some camera mounting devices is the quality of materials used in their fabrication. For example, this inventor is aware of certain camera mounts being offered for sale to the public which use suction cups to secure a camera to a motorcycle. Because of the speed and handling of sport bikes, this type of camera mount is not particularly stable and can fall off. This can create a danger to the rider and others on the road. As a result, riders using this type of mount sometimes resort to "duct-taping" it onto the bike. In addition, these types of mounts can be easily stolen because they are not bolted on or otherwise secured to the bike.

Other models made out of flat sheet metal have no horizontal strength and tend to cause large oscillations which result in poor filming quality and potential damage to the camera.

Damage to the camera can also result from using U.S. Patent 6,293,449 to McGuire and McGuire (1999) which is a mounting system designed to be attached to the handlebars of a vehicle. Positioning the camera on the handlebars of a motorcycle leaves it exposed to rocks and other road debris which can crack the lens or otherwise damage the camera not to mention the effect on film quality. As with Eidschun and Holtzman's patent (above) there is the potential that this type of mount can interfere with the rider's view, as well as balance and performance of the bike due to its positioning.

Therefore, the need exists for a simple, yet sturdy camera support device that will remain stable when attached to a motorcycle and will protect the camera from unnecessary damage.

Accordingly, the objects and advantages of the camera mount described in my above patent are: (a)it can be easily mounted to a motorcycle with no drilling or special tools; (b)the mounting bracket is slightly relieved on its bottom portion to prevent damage to the paint or denting of the motorcycle; (c)lightweight construction material such as CNC (Computerized Numeric Control) machined aluminum the results in less mass; (d)the camera can be easily attached and removed from the large camera platform; (e)it has an adjustable pivot for different views; (f)the camera can be rotated 360 degrees horizontally; (g)the camera can be moved forward or back on the extension arm to accommodate cameras of different weights and for rider comfort; (h)the long extension arm absorbs bumps and oscillations for better video quality and camera fife; (i)the lock down knob is extended out for better grip when tightening or adjusting; (j)fuel tank remains accessible without removal of camera mount; (k)modular design allows for mounting to several different styles or brands of motorcycles.

In addition, the simplicity of the camera mount's design makes it neat and professional looking. It does not obstruct the riding position and allows for riding without visual distraction. It is designed to sit low enough on the cycle to keep the camera out of the wind and protect the lens from getting hit with rocks or other debris.

The foregoing and other objects, features, and advantages of the invention will be apparent from the following more particular description of the preferred embodiments of the invention and as illustrated in the drawings.

### BRIEF SUMMARY OF THE INVENTION

This invention is for a camera mount designed for use on a motorcycle. It consists of an attachment means, an extension means, an adjustment means, and a camera platform all of which are interconnected to provide superior stability for the camera and filming.

### BRIEF DESCRIPTION OF THE DRAWINGS

FIG. 1 is an isometric view of the camera mount assembly.

FIG. 2A is a top view of the assembly of FIG. 1 shown without a camera attached.

FIG. 2B is a side view of the mount assembly of FIG. 2A.

FIG. 2C is a front view of the mount assembly of FIG. 2A.

FIG. 3 is a side view of the assembly of FIG. 2A shown with a camera attached.

FIG. 4A is a top view of the camera mount with camera attached shown installed on a motorcycle with aircraft style fuel filler.

FIG. 4B is a comprehensive view of the present invention shown installed on a motorcycle.

DRAWINGS - Reference Numerals

[0020.2]

1.tank bracket
2extension arm
3angle bracket
4adjustment knob
5spacer
6lock washer
7camera platform
8vibration dampening material
9tank bracket bolts
10bolts
11camera bolt
12camera
13fuel tank filler cap
14camera mount assembly
15windscreen

### DETAILED DESCRIPTION OF THE INVENTION

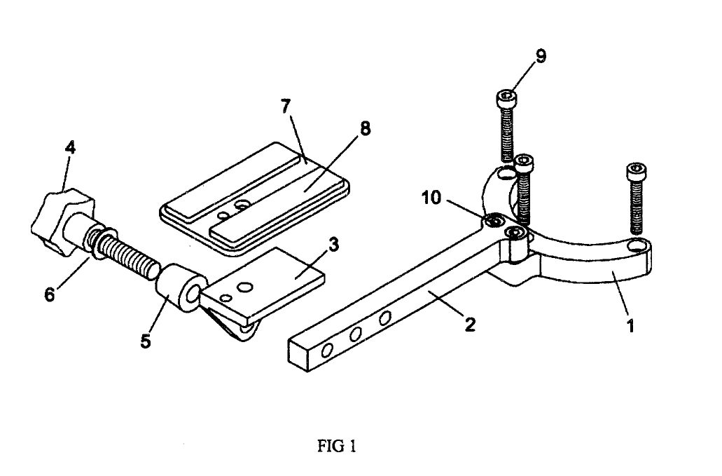

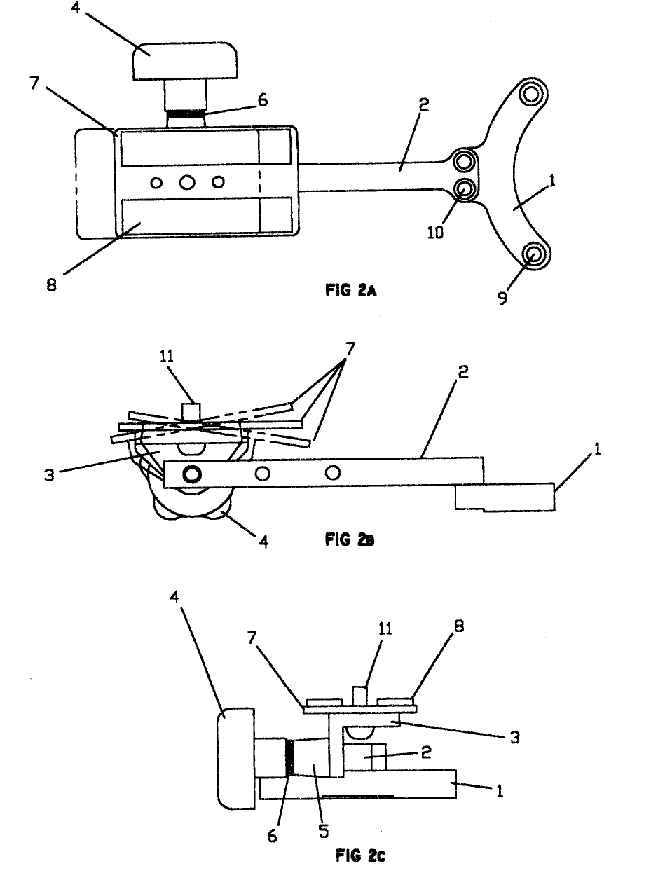

A preferred embodiment of the camera mount of the present invention is best illustrated in FIG. 1 and FIG. 2A (top view). Because it is lightweight yet extremely durable, I prefer that all of the parts except for adjustment knob 4, lock washer 6, and hook and loop pads 8, be crafted from CNC (computerized numeric control) machined lightweight aluminum. However, the present invention can be crafted from any variety of lightweight materials such as, but not limited to, high-carbon steel, titanium, or polycarbonate.

Referring to FIGS. 1-3, the camera mount assembly consists of a partial ring tank bracket 1 with two or more mounting holes dependent on application.

There is an extension arm 2 that attaches to tank bracket 1 with two small bolts 10. Extension arm 2 is drilled and tapped (illustr) to allow for various placements of an angle bracket 3.

Angle bracket 3 is mounted to extension arm 2 via threaded knob 4. A cylindrical spacer 5 and lock washer 6 for tightening and adjusting threaded knob 4.

A flat, rectangular camera platform 7 is fitted with vibration dampening material 8 and attaches to angle bracket 3 via camera bolt 11.

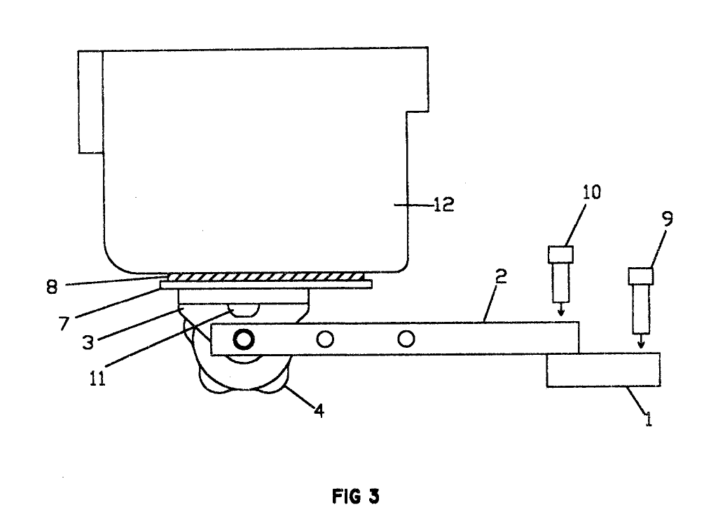

Referring to FIG. 3, a camera or other device 12 is mounted to camera platform 7 and secured with camera bolt 11.

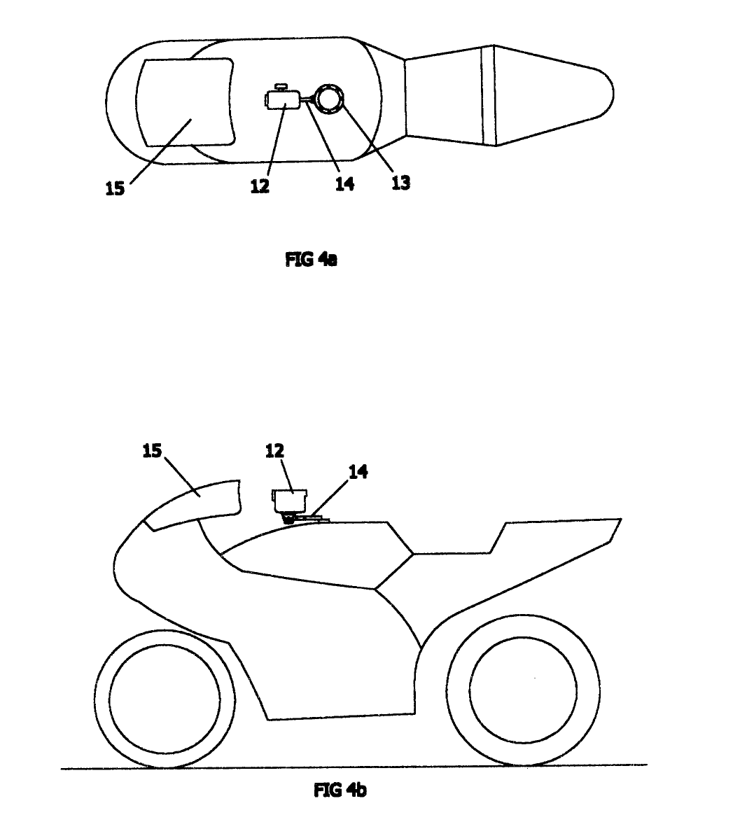

Referring to FIG. 4A, the entire camera assembly 14 is shown attached to a fuel tank filler cap 13 with bolts 9.

FIG. 4B shows the side view of the camera mount system and its placement on a motorcycle. The camera's positioning behind motorcycle's windscreen 15 keeps it protected from debris.

From the descriptions above, some of the advantages and features of the invention become evident:

As illustrated in FIG. 3, there are three holes on extension arm 2 which allow for the adjustment means (consisting of angle bracket 3, adjustor knob 4 and camera platform 7) to be moved backwards or forwards along the arm 2 depending on desired location.

Extension arm 2 is strong enough to absorb large oscillations from bumps in the road but not so unyielding as to send potentially damaging vibrations to the camera 12.

Referring to FIG. 2C, threaded knob 4 is fitted with a cylindrical spacer 5 to for easier access to the camera.

The vibration dampening material 8, as illustrated in FIG. 2A and 3, is added to the top of camera platform 7 and helps absorb vibrations that may damage a camera while providing some additional stabilization for a camera 12 as well.

Camera platform 7 as illustrated in FIG. 2A, can be rotated 180 degrees to accommodate different types and sizes of cameras. It can also rotate a full 360 degrees on the axis of camera bolt 11 to allow for different viewing and filming angles. Also, as is best illustrated in FIG. 2B, camera platform 7 and adjustor bracket 3 can pivot vertically on the axis of threaded knob 4 providing the user with even more camera angle options.

Thus the reader will see that the camera mount of the invention provides a simple yet extremely stable means of mounting a camera to motorcycle.

While the invention has been particularly shown and described above, the scope of it should not be, limited as such. For example, the camera mount assembly system can easily accommodate other small electronic (or other) devices such as GPS receivers, mobile phones, compact disc players and radar detectors. Also, tank bracket 1 can easily be exchanged for another size or style tank bracket to fit on a different style bike without the need to purchase a whole assembly.

Accordingly, the scope of the invention should be determined by the appended claims and their legal equivalents, rather than by the examples given.

1. A modular device for supporting a camera and attaching it to a motorcycle comprising:
(a) a solid, partial ring-shaped bracket with a plurality of holes drilled at spaced locations to accommodate a means for mounting it to an object,
(b) said bracket possesses a stand off portion which projects from the bracket's midpoint and whose underportion is slightly relieved,
(c) said stand off portion has holes to accommodate means for attaching
(d) a solid, horizontal shaft with three equidistantly spaced holes along its center which are drilled and tapped to accommodate
(e) a threaded knob or other means of securing and adjusting
(f) a substantially angled bracket which pivots vertically and serves as a base for
(g) a rectangular platform.

2. A modular supporting device comprising a partial ring-shaped bracket with a stand off portion, a shaft suitable for attachment of said shaft to said stand off portion, and an angled bracket suitable for adjustable attachment to said shaft, wherein said device is capable of supporting an electronic device when mounted on a motorcycle.

3. The modular supporting device of claim 2, wherein said device comprises a lightweight material.

4. The modular supporting device of claim 3, wherein said lightweight material is selected from the group consisting of aluminum, high-carbon steel, titanium and polycarbonate.

5. The modular supporting device of claim 2, wherein said partial ring-shaped bracket has holes for attaching said bracket to a motorcycle tank.

6. The modular supporting device of claim 2, wherein said stand off portion of said partial ring-shaped bracket has an underportion that is slightly relieved.

7. The modular supporting device of claim 2, wherein said shaft has a hole suitable for attaching said angled bracket to facilitate adjustment of said angled bracket through pivot movement.

8. The modular supporting device of claim 2, wherein said electronic device comprises a camera.

9. The modular supporting device of claim 2, wherein said electronic device is selected from the group consisting of a small electronic device, a GPS receiver, a mobile phone, a compact disc player and a radar detector.

10. The modular supporting device of claim 2, wherein said device further comprises a platform suitable for attachment to said angled bracket.

11. A device for attaching an electronic device to a motorcycle comprising means for attaching a bracket to a motorcycle tank, said bracket being capable of attachment to a shaft, and means for attaching an angled bracket to said shaft, wherein said device is capable of supporting an electronic device when mounted on a motorcycle.

12. The device of claim 11, wherein said device comprises a lightweight material.

13. The device of claim 12, wherein said lightweight material is selected from the group consisting of aluminum, high-carbon steel, titanium and polycarbonate.

14. The device of claim 11, wherein said bracket has holes for attaching said bracket to a motorcycle tank.

15. The device of claim 11, wherein said bracket has a stand off portion with an underportion that is slightly relieved.

16. The device of claim 11, wherein said shaft has a hole suitable for attaching said angled bracket to facilitate adjustment of said angled bracket through pivot movement.

17. The device of claim 11, wherein said electronic device comprises a camera.

18. The device of claim 11, wherein said electronic device is selected from the group consisting of a small electronic device, a GPS receiver, a mobile phone, a compact disc player and a radar detector.

19. The device of claim 11, wherein said device further comprises a platform suitable for attachment to said angled bracket.
